(19) United States
(12) Patent Application Publication
(10) Pub. No.: US 2023/0405508 A1
(43) Pub. Date: Dec. 21, 2023

(54) AIR FILTER CLEANING DEVICE

(71) Applicant: William L McLean, Jr., Amarillo, TX (US)

(72) Inventor: William L McLean, Jr., Amarillo, TX (US)

(21) Appl. No.: 17/844,683

(22) Filed: Jun. 20, 2022

(51) Int. Cl. B01D 46/71; B01D 46/72; B01D 46/04

(52) U.S. Cl. CPC B01D 46/71; B01D 46/72; B01D 46/04

(57) ABSTRACT

The air filter cleaning device provides a tool for efficiently cleaning an air filter. the air filter cleaning device includes an elongated coil extending between a first end and a second end. The coil includes a surface that defines a hollow interior extending between first end and second end such that the coil is configured to be tubular. the elongated straight portion is connected with the actuator via the swivel joint. The coil is placed into the cavity of the air filter. The actuator is actuated, thereby causing air to enter the first end, flow through the interior and exit the opening. The pressure of the air exiting the opening causes the coil to rotate relative to the air filter. As the coil rotates, the pressure of the air pushes dust and/or debris from the porous material of the air filter.

### FIELD OF THE INVENTION

This invention relates to filters. More particularly, it relates to a device for easily cleaning a filter.

### BACKGROUND

Filter, filtering or filters may refer to:
Filter (chemistry), a device which separates solids from fluids (liquids or gases) by adding a medium through which only the fluid can pass;
Filter (aquarium), critical components of both freshwater and marine aquaria;
Filter paper, a semi-permeable paper barrier placed perpendicular to a liquid or air flow. It is used to separate fine solids from liquids or air;
Air filter, a device composed of fibrous materials which removes solid particulates such as dust, pollen, mold, and bacteria from the air;
Oil filter, a filter to remove contaminants from engine oil, transmission oil, lubricating oil, or hydraulic oil;
Pneumatic filter, a device which removes contaminants from a compressed air stream;
Water filter, removes impurities from water by means of a fine physical barrier, a chemical process or a biological process.

Filters are critical in many cases to catch and remove particles, such as dust, dirt and other contaminants, however these filters often time clog up or become so heavy in contaminants that have been captured by the filter that they lose their effectiveness. The filters then need to be replaced although some utilize water and air to clean a filter, the contaminants still reside in cracks and crevices and then can be released into the air or liquid being filtered.

Accordingly, and in light of the foregoing, there is a need and desire for a device that can easily clean a filter by a person. There is also a need for the device to be cost effective and reusable.

### BRIEF DESCRIPTION OF THE DRAWINGS

These and other features, aspects, and advantages of the present disclosure will become better understood with regard to the following description, appended claims, and accompanying drawings where:

FIG. 1 is a side view of an air filter cleaning device 10, according to an embodiment of this disclosure;

FIG. 2 is a top view of an air filter cleaning device 10, according to an embodiment of this disclosure;

FIG. 3 is a bottom view of an air filter cleaning device 10, according to an embodiment of this disclosure;

FIG. 4 is a side view of an air filter cleaning device 10, according to an embodiment of this disclosure; and,

FIG. 5 is a perspective view of an air filter cleaning device 10, according to an embodiment, of this disclosure.

### DESCRIPTIVE KEY

10 air filter cleaning device
12 coil
14 first end
16 second end
20 surface
22 hollow interior
30 elongated straight portion
32 swivel joint
42 opening
50 actuator
F air filter

### DETAILED DESCRIPTION

The following disclosure is provided to describe various embodiments of an air filter cleaning device 10. Skilled artisans will appreciate additional embodiments and uses of the present invention that extend beyond the examples of this disclosure. Terms included by any claim that may be presented in any yet-to-be-filed non-provisional patent application are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one (1) of A, B, and C” should be read to permit any of A, B, or C singularly or in combination with the remaining elements. Additionally, such groups may include multiple instances of one (1) or more element in that group, which may be included with other elements of the group. All numbers, measurements, and values are given as approximations unless expressly stated otherwise.

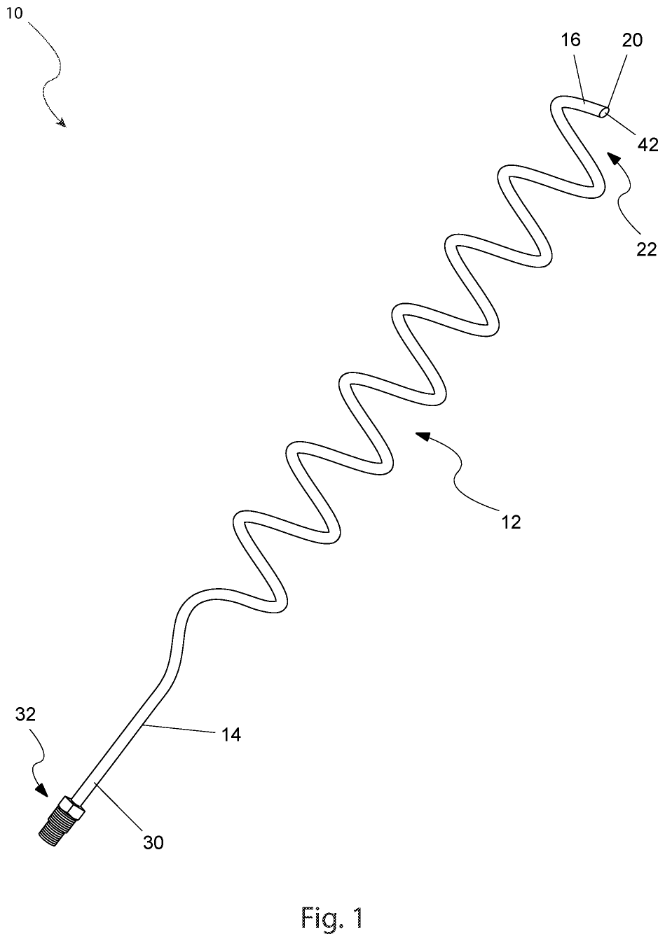

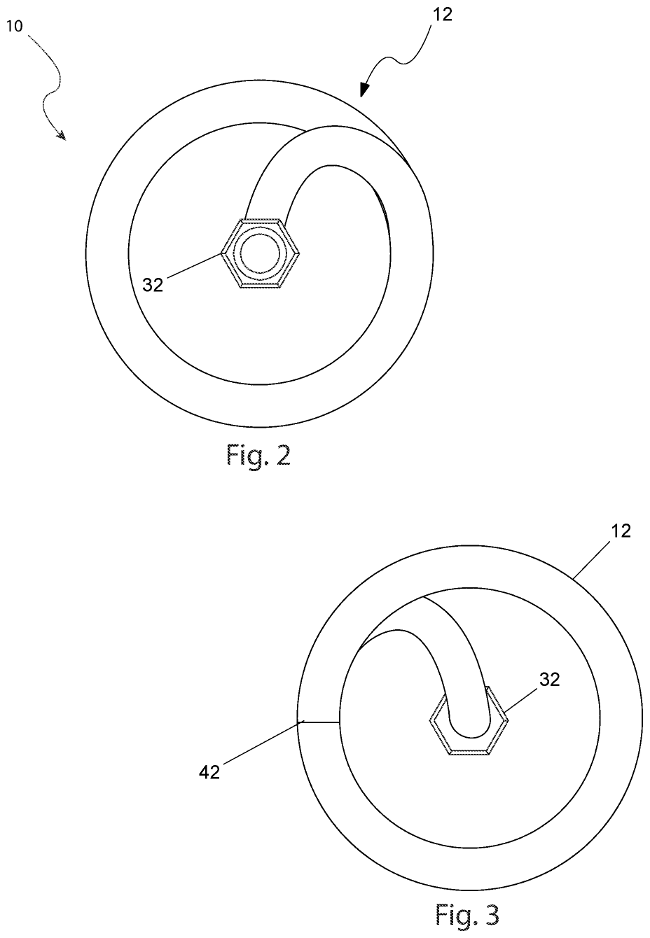

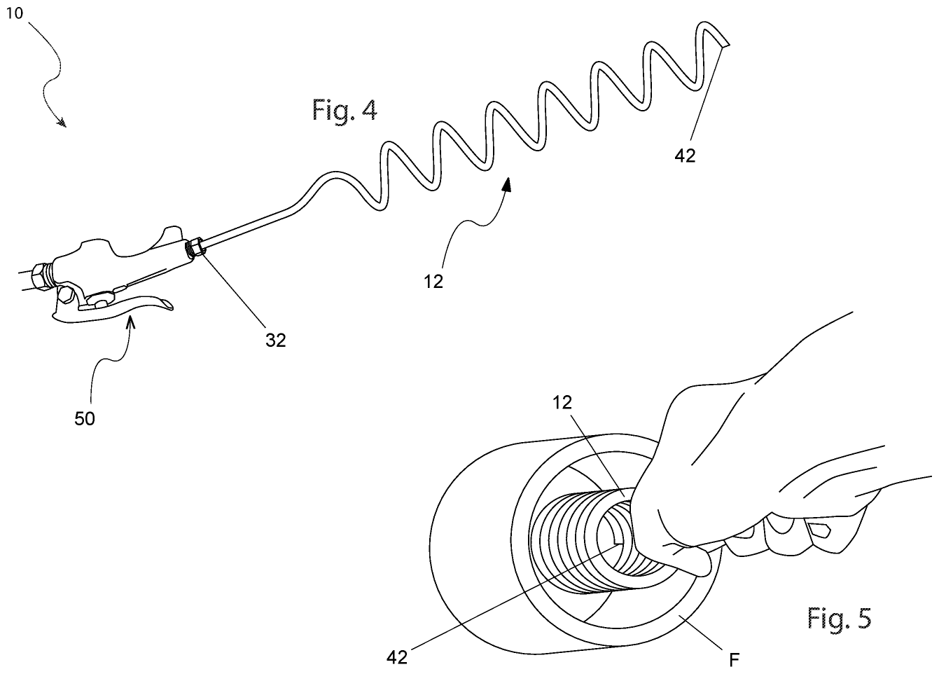

Various aspects of the present disclosure will now be described in detail, without limitation. Skilled readers should not view the inclusion of any alternative labels as limiting in any way. Referring now to FIGS. 1-5, an illustrative air filter cleaning device 10 will now be discussed in more detail.

The air filter cleaning device 10 provides a tool for efficiently cleaning an air filter F. the air filter cleaning device 10 includes an elongated coil 12 extending between a first end 14 and a second end 16. A coil 12 includes a surface 20 that defines a hollow interior 22 extending between first end 14 and second end 16 such that the coil 12 is configured to be tubular.

The first end 14 includes an elongated straight portion 30 which includes an attachment mechanism, for example, a swivel joint 32. The swivel joint 32 is configured to connect the elongated straight portion 30 with an actuator 50, as described herein, while allowing for relative rotation of the coil 12. The swivel joint 32 is configured to provide connection between a stationary tool, for example, an air compressor hose 40 and a rotating tool for example, by rotating the coil 12. The second end 16 includes an opening 42 disposed in in communication with an interior 22. In some embodiments, the actuator 50 includes an air compressor configured to push air into the second end 14, through the interior 22 and exiting the opening 42.

In some embodiments, an air filter F includes a tubular configuration having a porous material surrounding an inner surface. The inner surface defines a cavity configured for disposal of a portion of the air filter cleaning device 10.

In operation, the elongated straight portion 30 is connected with the actuator 50 via the swivel joint 32. The coil 12 is placed into the cavity of the air filter F. The actuator 50 is actuated, thereby causing air to enter the first end 14, flow through the interior 22 and exit the opening 42. The pressure of the air exiting the opening 42 causes the coil 12 to rotate relative to the air filter F. As the coil 12 rotates, the pressure of the air pushes dust and/or debris from the porous material of the air filter F. In some embodiments, the edges of the coil 12 can dislodge debris and/or dust from an internal surface of the air filter F.

While various aspects of the present invention have been described in the above disclosure, the description of this disclosure is intended to illustrate and not limit the scope of the invention. The invention is defined by the scope of the claims of a corresponding nonprovisional utility patent application and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the claims of a corresponding nonprovisional utility patent application.

What is claimed is:

1. An air filter cleaning device for easily cleaning an air filter, the device comprising:
a first end;
a second end;
an elongated coil, the elongated coil being securely coupled between the first end and the second end, the elongated coil comprising:
a surface, the surface having an interior;
a elongated straight portion;
an attachment mechanism, the attachment mechanism being coupled to the first end; and
an actuator, the actuator being coupled to the elongated strait portion of the elongated coil by the attachment mechanism, wherein the actuator having an air compressor, wherein the air compressor being for pushing air into the second end through the interior and exiting out an opening.

2. The device according to claim 1, wherein the interior of the surface being hollow.

3. The device according to claim 1, wherein the elongated coil having a tubular shape.

4. The device according to claim 1, wherein the attachment mechanism being a swivel joint.

5. The device according to claim 1, wherein the air compressor is coupled to the attachment mechanism by an air hose.
